(19) United States
(12) Patent Application Publication
(10) Pub. No.: US 2003/0214511 A1
(43) Pub. Date: Nov. 20, 2003

(54) Method and apparatus for managing multiple hardware color tables in a data processing system

(75) Inventors: Neal Richard Marion, Georgetown, TX (US); George F. Ramsay III, Cedar Park, TX (US)

Correspondence Address: Duke W. Yee, Carstens, Yee & Cahoon, LLP, P.O. Box 802334, Dallas, TX, 75380, US

(73) Assignees: International Business Machines Corporation, Armonk, NY; IBM Corporation

(21) Appl. No.: 10/150,005

(22) Filed: May 16, 2002

(51) Int. Cl. G09G 5/02

(52) U.S. Cl. 345/602

(57) ABSTRACT

A method, apparatus, and computer instructions for managing a plurality of color tables in a display device. A request is received for a requested colormap of a particular type. In response to the colormap being absent, a determination is made as to whether an empty color table is present. In response to an empty color table being absent, a determination is made as to whether a color table containing a current colormap of the particular type is present. The current colormap is replaced with the requested colormap in response to a current color table of the particular type being present.

### BACKGROUND OF THE INVENTION

1. Technical Field

The present invention relates generally to an improved data processing system, and in particular, to a method and apparatus for processing graphics data. Still more particularly, the present invention provides a method and apparatus for managing color tables in displaying graphics data.

2. Description of Related Art

Computer graphics concerns the synthesis or display of real or imaginary objects from computer-based models. In computer graphics systems, images are displayed on a display device to a user in two-dimensional and three dimensional forms. These images are displayed using pixels. A pixel is short for a picture element. One spot in a rectilinear grid of thousands of such spots that are individually “painted” to form an image produced on the screen by a computer or on paper by a printer. A pixel is the smallest element that display or print hardware and software can manipulate in creating letters, numbers, or graphics. These pixels and information relating to these pixels are stored in a buffer. The information describing a pixel is identified using a window ID (WID). A WID is used as an index into a window attribute table (WAT). The WAT contains information describing how a pixel will be displayed on the screen. For example, a WAT identifies depth, colormap, buffer, and gamma for a pixel.

With respect to colormaps, a hardware color table is employed typically to store pixel values or colors. For example, a hardware color table may contain 256 entries with one entry for each value in an 8 bit index. The colormap stored in a hardware color table contains the color values. Different types of color tables are used. One example is a pseudo-color system in which pixel colors are displayed on a display screen by using each pixel in the frame buffer as an index into the hardware color table, such as table 100 in FIG. 1. The corresponding value in the color table is displayed on the screen. In FIG. 1, the pixel value is 2, which indexes into entry 102, containing value 0x773910, which is used to display the pixel on the screen. In this example, the pseudo-color pixels are 8 bits in depth.

Another type of color system is direct color. In this system, each pixel in the frame buffer is broken down into component red, green, and blue values. Each value for these color bands is used as an index into a hardware color table, such as hardware color table 200 in FIG. 2. As can be seen, pixel 202 is broken down into the following values for red, green, and blue: 0x47, 0x03, and 0x02. 0x47 indexes to entry 204, 0x03 indexes to entry 206, and 0x02 indexes into entry 208. In each entry, the appropriate value is retrieved depending on the particular color. These values are joined as illustrated by value 210 and used to display the pixel on the screen. In these examples, the direct colormap is a 24 bit per pixel colormap.

On graphics adapters with multiple hardware color tables, resources are limited and should be managed to reduce technicolor effects on the screen. Technicolor is a result of a window or other object being displayed with the wrong color table values. Essentially the colors are incorrect for the particular window or object. The effect may range from just one color being displayed incorrectly to every color being displayed incorrectly, depending on how different the colormaps are in the system.

Currently, this problem is handled using a least recently used (LRU) algorithm to control color table usage. For example, if all the hardware color tables are in use and a new colormap is loaded, the colormap that has not been used for the longest time is replaced with the new colormap. The present invention recognizes that if the colormap being removed is of a different type, such as a direct colormap versus a pseudo-colormap, more severe technicolor effects may occur, especially if the different types of colormaps have different bit sizes.

Therefore, it would be advantageous to have an improved method, apparatus, and computer instructions for managing a hardware color table in such a manner that severe technicolor effects are reduced.

### SUMMARY OF THE INVENTION

The present invention provides a method, apparatus, and computer instructions for managing a plurality of color tables in a display device. A request is received for a requested colormap of a particular type. In response to the colormap being absent, a determination is made as to whether an empty color table is present. In response to an empty color table being absent, a determination is made as to whether a color table containing a current colormap of the particular type is present. The current colormap is replaced with the requested colormap in response to a current color table of the particular type being present.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a known color table for a pseudo-color system;

FIG. 2 is a diagram of a known color table for a direct color system;

FIG. 3 is a pictorial representation of a data processing system in which the present invention may be implemented in accordance with a preferred embodiment of the present invention;

FIG. 4 is a block diagram illustrating a data processing system in which the present invention may be implemented;

FIG. 5 is a block diagram illustrating a graphics adapter in accordance with a preferred embodiment of the present invention; and

FIG. 6 is a flowchart of a process used for managing color tables in accordance with a preferred embodiment of the present invention.

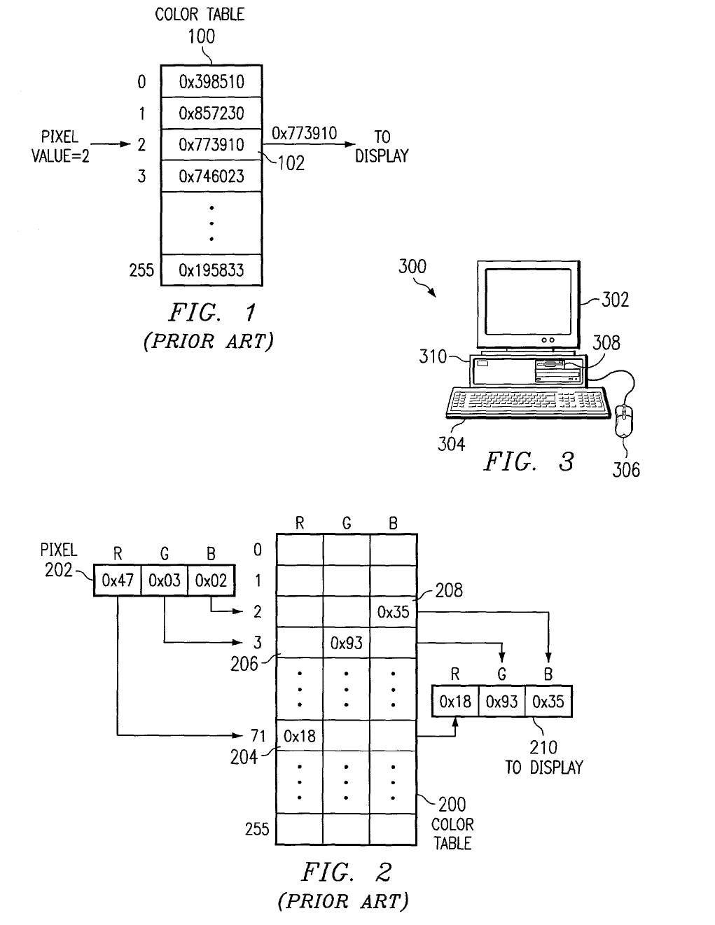

### DETAILED DESCRIPTION OF THE PREFERRED EMBODIMENT

With reference now to the figures and in particular with reference to FIG. 3, a pictorial representation of a data processing system in which the present invention may be implemented is depicted in accordance with a preferred embodiment of the present invention. A computer 300 is depicted which includes a system unit 310, a video display terminal 302, a keyboard 304, storage devices 308, which may include floppy drives and other types of permanent and removable storage media, and mouse 306. Additional input devices may be included with personal computer 300. Computer 300 can be implemented using any suitable computer, such as an IBM e-Server computer or IntelliStation computer, which are products of International Business Machines Corporation, located in Armonk, N.Y. Although the depicted representation shows a computer, other embodiments of the present invention may be implemented in other types of data processing systems, such as a network computer. Computer 300 also preferably includes a graphical user interface that may be implemented by means of systems software residing in computer readable media in operation within computer 300.

With reference now to FIG. 4, a block diagram illustrating a data processing system is shown in which the present invention may be implemented. Data processing system 400 is an example of a computer, such as computer 300 in FIG. 3, in which code or instructions implementing the processes of the present invention may be located. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. In the depicted example, local area network (LAN) adapter 410, small computer system interface SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. The processes of the present invention may be used to manage rendering of data by graphics adapter 418 or audio/video adapter 419.

Expansion bus interface 414 provides a connection for a keyboard and mouse adapter 420, modem 422, and additional memory 424. SCSI host bus adapter 412 provides a connection for hard disk drive 426, tape drive 428, and CD-ROM drive 430. Typical PCI local bus implementations will support three or four PCI expansion slots or add-in connectors.

An operating system runs on processor 402 and is used to coordinate and provide control of various components within data processing system 300 in FIG. 3. The operating system may be a commercially available operating system such as OS/2, which is available from International Business Machines Corporation. “OS/2” is a trademark of International Business Machines Corporation. An object oriented programming system such as Java may run in conjunction with the operating system and provides calls to the operating system from Java programs or applications executing on data processing system 400. “Java” is a trademark of Sun Microsystems, Inc. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. Also, the processes of the present invention may be applied to a multiprocessor data processing system.

For example, data processing system 400, if optionally configured as a network computer, may not include SCSI host bus adapter 412, hard disk drive 426, tape drive 428, and CD-ROM 430, as noted by dotted line 432 in FIG. 4 denoting optional inclusion. In that case, the computer, to be properly called a client computer, must include some type of network communication interface, such as LAN adapter 410, modem 422, or the like. As another example, data processing system 400 may be a stand-alone system configured to be bootable without relying on some type of network communication interface, whether or not data processing system 400 comprises some type of network communication interface. As a further example, data processing system 400 may be a Personal Digital Assistant (PDA) device which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

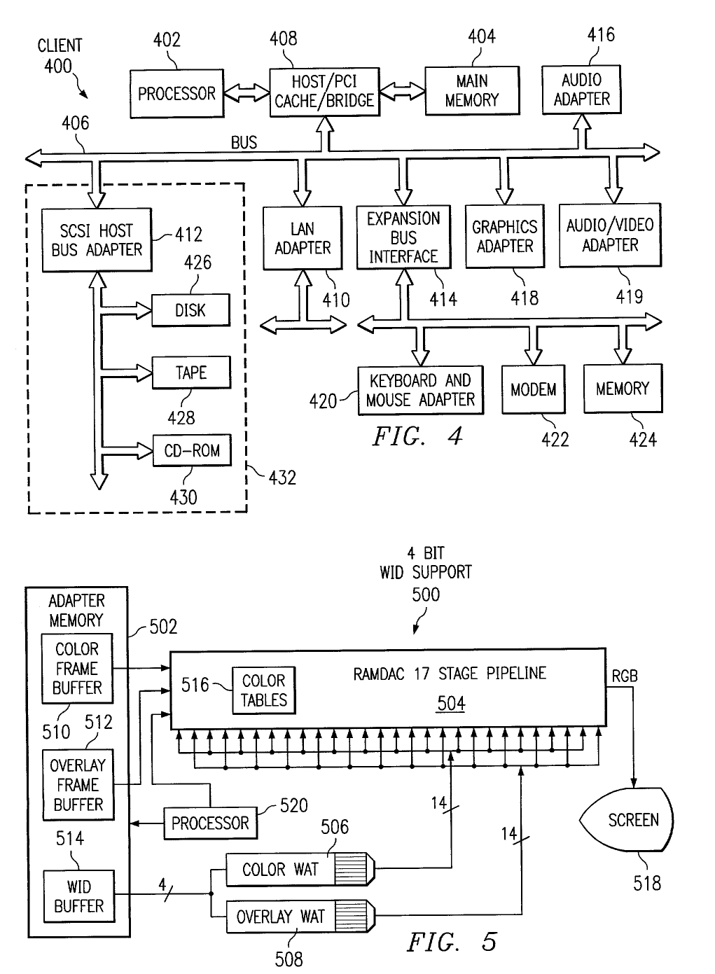

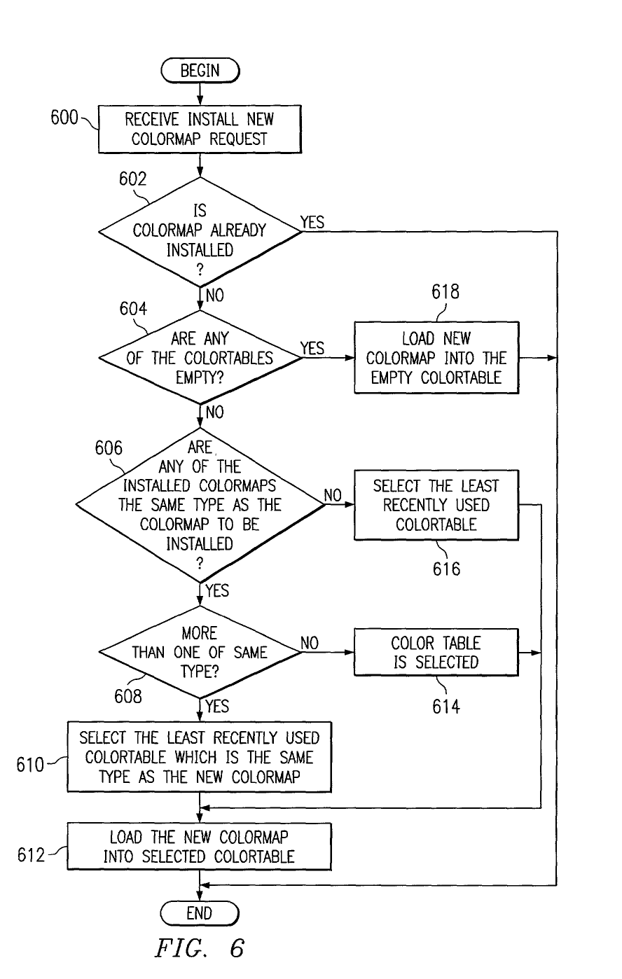

Turning next to FIG. 5, a block diagram illustrating a graphics adapter is depicted in accordance with a preferred embodiment of the present invention. Graphics adapter 500 is an example of a graphics adapter, such as graphics adapter 418 in FIG. 4. Graphics adapter 500 includes an adapter memory 502, a random access memory digital to analog converter (RAMDAC) 504, a color WAT table 506, and an overlay WAT table 508. Adapter memory 502 includes a color frame buffer 510, an overlay frame buffer 512, and a WID buffer 514. The two frame buffers contain pixels, which are sent to RAMDAC 504 for output to a display device. RAMDAC 504 is a graphics controller chip that maintains the color palette and converts data from memory into analog signals for a display device.

WID buffer 514 contains WIDs that are used as an index into color WAT table 506 and overlay WAT table 508. Each of these WAT tables describes how a pixel will be rendered on a display device.

RAMDAC 504 contains color tables 516. These color tables form the color table hardware in which colormaps are loaded and stored for displaying pixels on screen 518. In addition, graphics adapter 500 includes a processor 520, which serves to perform various functions within graphics adapter 500. These functions include, for example, managing color tables 516 within RAMDAC 504.

The present invention provides an improved method, apparatus, and computer instructions for managing colormaps in a color table system, such as color tables 516. The mechanism of the present invention does not manage color tables by using merely a least recently used (LRU) algorithm to remove a least recently used colormap. Instead, the mechanism of the present invention selects a colormap of the same type for removal or replacement by the new colormap. In many instances, colormaps of the same type may be identical or differ only in a few entries. Thus, selecting a colormap in a color table for replacement based on the colormap type helps reduce technicolor in the display of windows or other objects.

If more than one colormap of the same type are present, a LRU algorithm may be used to select which one of these colormaps of the same type are to be removed. The colormap type or colormap of a particular type is for example, direct, pseudo, or gray scale. The type for a colormap also may be the particular bit depth, such as, for example, pseudo with 8 bits, pseudo with 24 bits, direct with 24 bits, gray scale with 8 bits, and gray scale with 24 bits.

Turning now to FIG. 6, a flowchart of a process used for managing color tables is depicted in accordance with a preferred embodiment of the present invention. The process illustrated in FIG. 6 may be implemented in graphics adapter 500 in FIG. 5 to manage color tables 516 in FIG. 5. Specifically, this process may be implemented in a processor, such as processor 520, in FIG. 5. Alternatively, the process could be implemented in the system's central processing unit, such as processor 402 in FIG. 4.

The process begins by receiving a request to install a new colormap (step 600). A determination is made as to whether the colormap has already been installed in the color tables (step 602). If the colormap has not already been installed, a determination is made as to whether any of the color tables are empty (step 604). If none of the color tables are empty, a determination is then made as to whether any of the colormaps are the same type as the colormap that is to be installed (step 606).

If one or more color tables containing colormaps of the same type are present, a determination is made as to whether more than one color table contains a colormap of the same type (step 608). If more than one color table is present, the least recently used color table containing a colormap of the same type as the new colormap is selected (step 610). The new colormap is loaded into the selected color table (step 612) with the process terminating thereafter.

With reference again to step 608, if more than one color table containing a colormap of the same type is not present, this color table is identified as the selected color table (step 614) with the process then proceeding to step 612 as described above. Turning back to step 606, if no color tables containing colormaps of the same color type are present, then the least recently used colormap table is selected (step 616) with the process then proceeding to step 612. In step 616, the colormap type is not used in the selection process.

With reference again to step 604, if one of the color tables is empty, then the new colormap is loaded into the empty color table (step 618) with the process terminating thereafter. With reference again to step 602, if the colormap is already installed, the process terminates without taking any additional action.

Thus, the present invention provides an improved method, apparatus, and computer instructions for managing color tables in a data processing system. Color table management using the mechanism of the present invention reduces technicolor effects. The mechanism of the present invention replaces a color table with a new color table based on the color table type to reduce the technicolor effects.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a plurality of color tables in a display device, the method comprising:
receiving a request for a requested colormap of a particular type;
responsive to the colormap being absent, determining whether an empty color table is present;
responsive to an empty color table being absent, determining whether a color table containing a current colormap of the particular type is present; and
responsive to the current colormap of the particular type being present, replacing the current colormap with the requested colormap.

2. The method of claim 1 further comprising:
responsive to a plurality of current colormaps of the particular type being present, replacing one of the plurality of current colormaps with the requested colormap on a least recently used basis.

3. The method of claim 1 further comprising:
responsive to a current colormap of the particular type being absent, replacing one of the plurality of colormaps with the requested colormap on a least recently used basis.

4. The method of claim 1, wherein the particular type is at least one of a direct colormap and a pseudo colormap.

5. A method in a data processing system for managing a plurality of colormaps, the method comprising:
receiving a request for a particular colormap that is absent from the set of colormaps; and
selectively replacing a colormap from the plurality of colormaps based on colormap type.

6. The method of claim 5, wherein the selectively replacing step comprises:
determining whether an empty color table is present;
replacing the colormap having a same colormap type as the particular colormap from the plurality of colormaps if an empty color table is absent.

7. The method of claim 6, wherein the replacing step is performed on a least recently used basis.

8. The method of claim 6 further comprising:
determining whether a colormap having the same colormap type as the particular colormap is present in the plurality of color tables; and
responsive to an absence of a colormap within the plurality of colormaps having the same colormap type as the particular colormap in the plurality of color tables, replacing a selected colormap within the plurality of colormaps with the particular colormap on a least recently used basis.

9. The method of claim 5, wherein the colormap type is at least one of a direct colormap and a pseudo colormap.

10. A display apparatus comprising:
a first frame buffer for storing a first set of pixels;
a second frame buffer for storing a second set of pixels;
a color window attribute table storing display information;
an overlay window attribute table storing display information, wherein all entries in the overlay window attribute table are identical;
a window identifier buffer connected to the color window attribute table and the overlay window attribute table, wherein the window identifier buffer stores window identifiers used to identify display information for the first set of pixels and for the second set of pixels;
a random access memory digital to analog converter unit connected to the first frame buffer, the second frame buffer, the color window attribute table, and the overlay window attribute table and having a connection configured for connection to a display device, wherein the random access memory digital to analog converter unit receives pixels for display from the first frame buffer and the second frame buffer and displays the pixels using display information from the color window attribute table and the overlay window attribute table; and
a processing unit, wherein the processing unit receives a request for a requested colormap of a particular type; determines whether an empty color table is present in response to the colormap being absent; determines whether a color table containing a current colormap of the particular type is present in response to an empty color table being absent; replace the at current colormap with the requested colormap in response to a current colormap of the particular type being present.

11. The display apparatus of claim 10, wherein the processing unit is located in the graphics adpater.

12. A data processing system for managing a plurality of color tables in a display device, the data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request for a requested colormap of a particular type; determine whether an empty color table is present in response to the colormap being absent; determine whether a color table containing a current colormap of the particular type is present in response to an empty color table being absent; and replace the current colormap with the requested colormap in response to a current colormap of the particular type being present.

13. A data processing system for managing a plurality of colormaps, the data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request for a particular colormap that is absent from the set of colormaps; and selectively replace a colormap from the plurality of colormaps based on colormap type.

14. A data processing system for managing a plurality of color tables in a display device, the data processing system comprising:
receiving means for receiving a request for a requested colormap of a particular type;
first determining means, responsive to the colormap being absent, for determining whether an empty color table is present;
second determining means, responsive to an empty color table being absent, for determining whether a color table containing a current colormap of the particular type is present; and
replacing means, responsive to a current colormap of the particular type being present, for replacing the current colormap with the requested colormap.

15. The data processing system of claim 14, wherein the replacing means is a first replacing means and further comprising:
second replacing means, responsive to a plurality of current colormaps of the particular type being present, for replacing one of the plurality of current colormaps with the requested colormap on a least recently used basis.

16. The data processing system of claim 14, wherein the replacing means is a first replacing means and further comprising:
second replacing means, responsive to a current colormap of the particular type being absent, for replacing one of the plurality of colormaps with the requested colormap on a least recently used basis.

17. The data processing system of claim 14, wherein the particular type is at least one of a direct colormap and a pseudo colormap.

18. A data processing system for managing a plurality of colormaps, the data processing system comprising:
receiving means for receiving a request for a particular colormap that is absent from the set of colormaps; and
selective replacing means for selectively replacing a colormap from the plurality of colormaps based on colormap type.

19. The data processing system of claim 18, wherein the selective replacing means comprises:
determining means for determining whether an empty color table is present;
replacing means for replacing the colormap having a same colormap type as the particular colormap from the plurality of colormaps if an empty color table is absent.

20. The data processing system of claim 19, wherein the replacing means is performed on a least recently used basis.

21. The data processing system of claim 19, wherein the determining means is a first determining means and the replacing means is a first replacing means and further comprising:
second determining means for determining whether a colormap having the same colormap type as the particular colormap is present in the plurality of color tables; and
second replacing means, responsive to an absence of a colormap within the plurality of colormaps having the same colormap type as the particular colormap in the plurality of color tables, for replacing a selected colormap within the plurality of colormaps with the particular colormap on a least recently used basis.

22. The data processing system of claim 18, wherein the colormap type is at least one of a direct colormap and a pseudo colormap.

23. A computer program product in a computer readable medium for managing a plurality of color tables in a display device, the computer program product comprising:
first instructions for receiving a request for a requested colormap of a particular type;
second instructions, responsive to the colormap being absent, for determining whether an empty color table is present;
third instructions, responsive to an empty color table being absent, for determining whether a color table containing a current colormap of the particular type is present; and
fourth instructions, responsive to a current colormap of the particular type being present, for replacing the current colormap with the requested colormap.

24. A computer program product in a computer readable medium for managing a plurality of colormaps, the computer program product comprising:
first instructions for receiving a request for a particular colormap that is absent from the set of colormaps; and
second instructions for selectively replacing a color table from the plurality of colormaps based on colormap type.
